(19) United States
(12) Patent Application Publication
(10) Pub. No.: US 2001/0019381 A1
(43) Pub. Date: Sep. 6, 2001

(54) Liquid crystal display device

(76) Inventors: Jae-Lag Ma, Kumi-shi (KR); Seung-Jun Han, Kumi-shi (KR)

Correspondence Address: Song K. Jung, LONG ALDRIDGE & NORMAN LLP, Suite 600, 701 Pennsylvania Avenue N.W., Washington, DC, 20004, US

(21) Appl. No.: 09/748,277

(22) Filed: Dec. 27, 2000

(30) Foreign Application Priority Data
Dec. 29, 1999 (KR) 1999-65034

(51) Int. Cl. G02F 1/1335

(52) U.S. Cl. 349/96; 349/110

(57) ABSTRACT

The present invention discloses a liquid crystal display device, which includes an upper polarizer; an upper substrate under the upper polarizer; a liquid crystal layer under the upper substrate; a lower substrate under the liquid crystal layer; a lower polarizer under the lower substrate, the lower polarizer including at least one light shielding film in the peripheral portion; and a backlight device positioned under the lower polarizer.

This application claims the benefit of Korean Patent Application No. 1999-65034, filed on Dec. 29, 1999, under 35 U.S.C. § 119, the entirety of which is hereby incorporated by reference.

### BACKGROUND OF THE INVENTION

1. Field of the Invention

The present invention relates to a liquid crystal display (LCD) device. More particularly it relates to the structure of a substrate and of a backlight device for an LCD.

2. Description of Related Art

A liquid crystal display (LCD) device uses the optical anisotropy and polarization properties of liquid crystal molecules to produce a predetermined image. Liquid crystal molecules have a definite orientation that results from their peculiar characteristics. The specific orientation can be modified by an electric field that is applied across the liquid crystal molecules. In other words, electric fields applied across the liquid crystal molecules can change the orientation of the liquid crystal molecules. Due to optical anisotropy, incident light is refracted according to the orientation of the liquid crystal molecules.

In general, liquid crystal display (LCD) devices use thin film transistors (TFTs) as switching elements that control the electric fields applied across the liquid crystal molecules. An active matrix LCD (AM-LCD) incorporates a matrix of thin film transistors (TFTs) and pixel electrodes. Active matrix LCD (AM-LCD) are beneficial in that they can have high resolution and can be superior to alternative types when displaying moving images.

FIG. 1 is a schematic cross-sectional view of an LCD device that employs a black pad (see below) according to the conventional art. As shown in FIG. 1, the LCD panel 20 has a lower substrate 2, an upper substrate 4, and an interposed liquid crystal layer (not shown). The lower substrate 2, which is referred to as an array substrate, has a TFT (not shown) that acts as a switching element to change the orientation of the liquid crystal molecules in the liquid crystal layer. The upper substrate 4 includes a color filter (not shown) that produces a color pixel image, and a common electrode (not shown) on the color filter. The common electrode serves as a corresponding electrode for the pixel electrode (not shown). Together, voltages applied to those electrodes produce an electric field across the liquid crystal layer. An upper polarizer 14 is positioned on the upper substrate 4 and a lower polarizer 12 is positioned under the lower substrate 2. Upper and lower retardation films (not shown) can be formed in the upper and lower substrates as needed.

In a transmissive LCD device, a backlight device 30 is arranged under the LCD panel 20. A black pad 40 is positioned on the upper peripheral portion of the backlight device 30. This black pad 40 acts as a light shield that prevents the light from coming through the peripheral potion of the backlight device 30 and leaking out the LCD panel 20.

The function of the black pad 40 will be explained again, and a more detailed structure of the backlight device 30 is provided subsequently.

FIG. 2 shows a conventional backlight device used in an LCD device. As shown in FIG. 2, the conventional backlight device 30 comprises a U-shaped lamp reflector 32, a light guide plate 33, and a lamp 31 that is positioned at one side of a lamp housing 39. In some applications two or more two lamps can be used, for example, in high brightness monitors and TVs.

The lamp reflector 32 surrounds the lamp 31 such that the light from the lamp 31 is reflected by the lamp reflector 32 and passed through the light guide plate 33. A plurality of the sheets (35-38) are formed over the light guide plate 33. Stacked are a diffusion sheet 35 for diffusing the light from the light guide plate 33, at least one prism sheet 36 (and 37) for accumulating the light and increasing the brightness, and a protective sheet 38 for protecting the prism sheet 36 (and 37). Especially in LCD devices used for monitors or TVs, more prism sheets are required to increase the brightness.

FIG. 3, a schematic cross-sectional view of an LCD device, shows that the light 10 from the backlight device 30 as it is projected into the LCD panel 20. The light 10 from the backlight device 30 is reflected in the peripheral portion “A” of the LCD panel and then travels to the portion “B” of the backlight device 30. At this time, the reflected light emanated from the peripheral portion “A” constructively interferes with each other. This constructive interference increases the brightness of the surface of the potion “B” as compared to that of the surroundings. This brightness results in a bright line, i.e., the interference maximum.

To prevent the bright line, referring back to FIG. 1, the conventional art uses the black pad 40.

However, as shown in FIG. 4, some problems occur when using a black pad. For example, devices that use the black pad are difficult to manufacture. Moreover, because of assembly tolerances the bright line, light leakage, and defects in covering the end portion of the display area of the LCD panel can result.

When the black pad 40a is arranged toward the outer side of the backlight device 30, instead of at its optimum position, a bright line is created by the solid line 11 and the black pad 40a is not totally operative. When the black pad 40b is arranged toward the inner side of the backlight device 30, instead of at its optimum position, the end portion of the display area of the LCD panel 20 is covered and thus will be a “non-display” area as depicted by the dotted line 12.

These problems also arise when black ink is printed on the surface of the sheets in place of the black pad used in the conventional art.

### SUMMARY OF THE INVENTION

To overcome the problems described above, the principles of the present invention provide a liquid crystal display device that prevents the bright line caused by reflected light from the LCD panel regardless of the assembly tolerance.

In order to achieve the above, the principles of the present invention provide a liquid crystal display (LCD) device that includes an upper polarizer, an upper substrate under the upper polarizer, a liquid crystal layer under the upper substrate, a lower substrate under the liquid crystal layer, and a lower polarizer under the lower substrate. The lower polarizer includes at least one light shielding film in a peripheral portion. Such an LCD further includes a backlight device under the lower polarizer.

The light shielding film is formed by coating or printing materials that absorb light. The light shielding film is beneficially formed in the four peripheral sides of the lower polarizer. The light shielding film beneficially has a black color.

It is to be understood that both the foregoing general description and the following detailed description are exemplary and explanatory and are intended to provide further explanation of the invention as claimed.

### BRIEF DESCRIPTION OF THE DRAWINGS

For a more complete understanding of the present invention and the advantages thereof, reference is now made to the following descriptions taken in conjunction with the accompanying drawings, in which like reference numerals denote like parts, and in which:

FIG. 1 is a typical schematic cross-sectional view of an LCD device that employs a black pad according to a conventional art;

FIG. 2 a partial cross-sectional view illustrating a backlight device according the conventional art;

FIG. 3 is a schematic cross-sectional view illustrating the configuration of an LCD device that does not employ a black pad;

FIG. 4 is a schematic cross-sectional view of FIG. 1;

FIG. 5 is a schematic cross-sectional view of an LCD device according to the principles of the present invention;

FIG. 6 is a plan view of a lower polarizer used in the LCD device of FIG. 5; and

FIG. 7 is a schematic cross-sectional view of FIG. 5.

### DETAILED DESCRIPTION OF AN ILLUTRATED EMBODIMENT

Reference will now be made in detail to an illustrated embodiment of the present invention, the example of which is shown in the accompanying drawings. All similar or same elements have similar or same drawing numbers as in the illustrated conventional art devices.

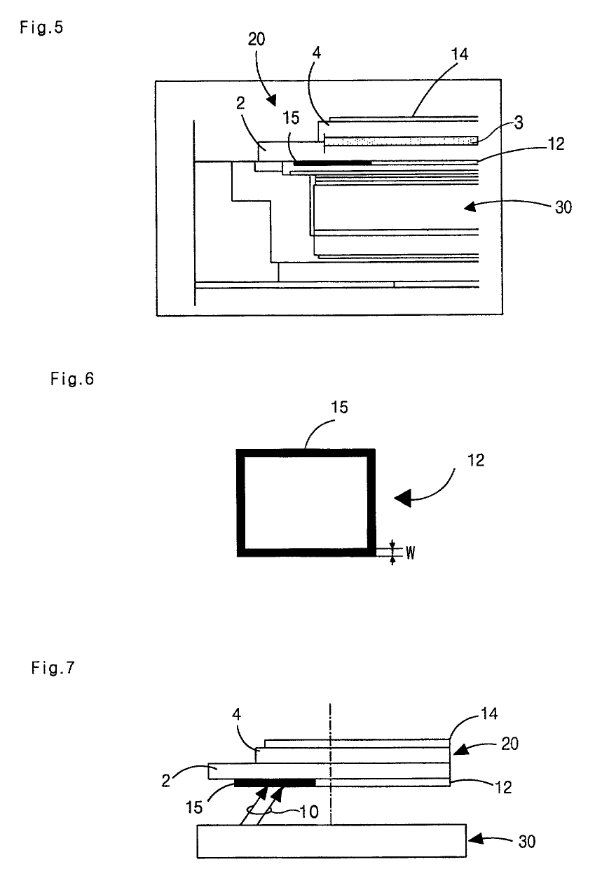

FIG. 5 is a schematic cross-sectional view of an LCD device that is in accord with the principles of the present invention. As shown in FIG. 5, the LCD panel 20 has a lower substrate 2, an upper substrate 4, and an interposed liquid crystal layer 3. The lower substrate 2, referred to as an array substrate, has a TFT (not shown) that acts as a switching element to change the orientation of the liquid crystal molecules in the liquid crystal layer. The upper substrate 4 includes a color filter (not shown) that produces a color pixel image, and a common electrode (not shown) on the color filter. The common electrode serves as a corresponding electrode for the pixel electrode (not shown). Together, voltages applied to those electrodes produce an electric field across the liquid crystal layer. An upper polarizer 14 is positioned on the upper substrate 4 and a lower polarizer 12 is positioned under the lower substrate 2. Upper and lower retardation films (not shown) can be formed as required. In the illustrated transmissive LCD device, a backlight device 30 is arranged under the LCD panel 20.

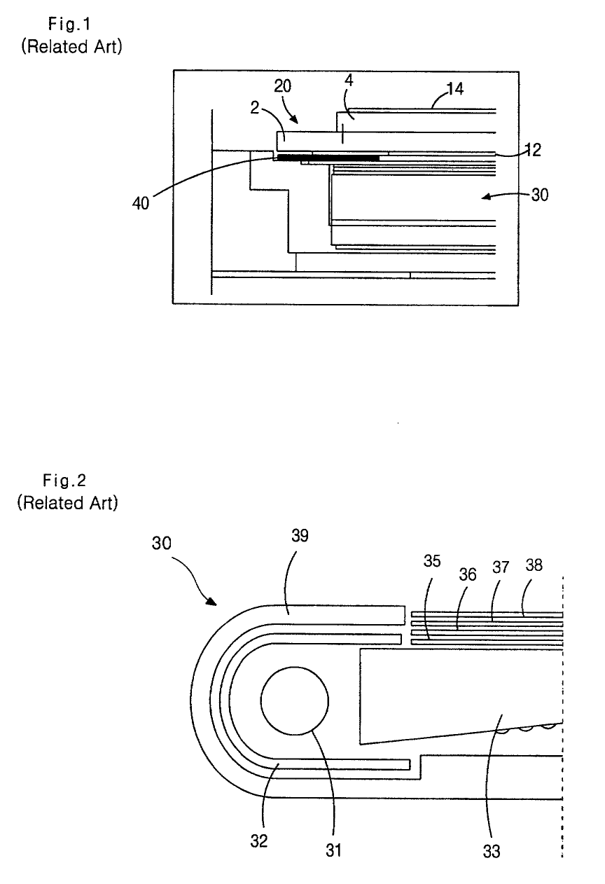

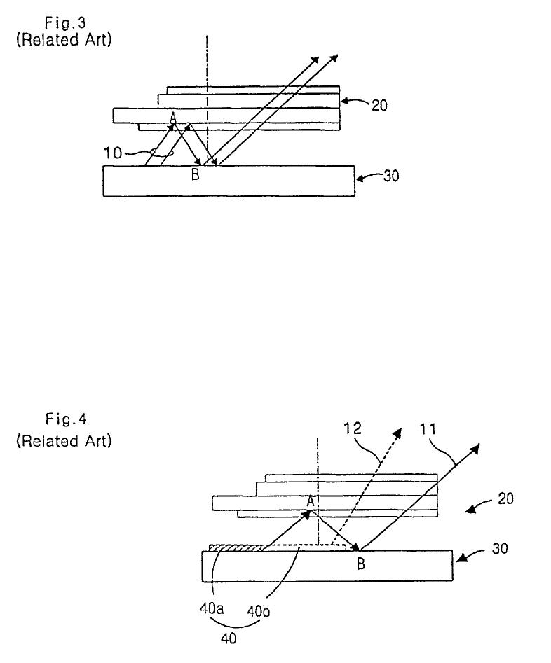

As described above, the structure and the constitutional elements are substantially similar to these of FIGS. 1 and 2.

However, referring to FIG. 6, the lower polarizer 12 of the LCD panel 20 has a light shielding film 15 along its four peripheral sides. The light shielding film 15 is formed by coating or printing a light absorbing material on the lower polarizer. Moreover, the light shielding film 15 beneficially has a black color.

The width “W” of the light shielding region 15 can be adjusted and fixed up to the width “W” that prevents a bright line. That width “W” depends on the particular LCD panel.

Referring to a schematic view of FIG. 7, some of the light 10 from the backlight device 30 is absorbed by the light shielding film 15. Thus, the absorbed light is not reflected in the LCD panel 20 and does not travel to the backlight device 30 again. Moreover, the light shielding film 15 decreases the reflection of the light 10 from the backlight device 30. Accordingly, bright lines, i.e., the interference maxima, do not occur due to the fact that the light does not constructively interfere.

Even if the assembly tolerances between the backlight device 30 and the LCD panel 20 are exceeded during assembling, reflection is prevented in the determined area, regardless of the assembly tolerance, due to the fact that the light shielding film 15 is already in the reflective area of the LCD panel 20.

Although the light shielding film 15 is shown being formed along the four peripheral sides of the polarizer 12, this is not required. For example, the light shielding film could be formed along only one peripheral side (or two, or three).

As described above, the principles of the present invention provide a method of preventing a bright line in an LCD device that includes an LCD panel having a lower polarizer and a backlight device under the LCD panel. Since the lower polarizer has at least one light shielding film in the peripheral sides, the bright line can be prevented by preventing reflections in the LCD panel. When the light shielding film is formed on (or in) the lower polarizer using a coating or printing material that absorb light, a black pad is not needed on the backlight device. Furthermore, a bright line can be prevented regardless of assembly tolerances.

An LCD device according to the principles of the present invention has the following advantages.

First, a bright line resulting from constructive interference of reflected light is prevented, regardless of assembly tolerance.

Second, a defect of covering the end portion of the display area, which is caused by the assembly tolerance, is prevented.

Third, the difficulty of manufacture is reduced by eliminating the black pad.

Moreover, the present invention can be adopted for use in monitors and TVs which need a high brightness.

While the invention has been particularly shown and described with reference to an illustrated embodiment, it will be understood by those skilled in the art that changes in form and detail may be made without departing from the spirit and scope of the invention.

What is claimed is:

1. A liquid crystal display (LCD) device, comprising:
an upper polarizer;
an upper substrate under the upper polarizer;
a liquid crystal layer under the upper substrate;
a lower substrate under the liquid crystal layer;
a lower polarizer under the lower substrate, the lower polarizer including at least one light shielding film in a peripheral portion; and
a backlight device positioned under the lower polarizer.

2. A liquid crystal display (LCD) device of claim 1, wherein the light shielding film is formed by coating materials that absorb the light.

3. A liquid crystal display (LCD) device of claim 1, wherein the light shielding film is formed by printing materials that absorb the light.

4. A liquid crystal display (LCD) device of claim 1, wherein the light shielding film is formed in the four peripheral sides of the lower polarizer.

5. A liquid crystal display (LCD) device of claim 1, wherein the light shielding film has a black color.
